(19) United States
(12) Patent Application Publication
(10) Pub. No.: US 2009/0063033 A1
(43) Pub. Date: Mar. 5, 2009

(54) Method For Operating A Navigation System

(76) Inventor: Thorsten W. Schmidt, Kitzingen (DE)

Correspondence Address: QUARLES & BRADY LLP, 411 E. WISCONSIN AVENUE, SUITE 2040, MILWAUKEE, WI, 53202-4497, US

(21) Appl. No.: 12/194,684

(22) Filed: Aug. 20, 2008

(30) Foreign Application Priority Data
Aug. 27, 2007 (DE) 10 2007 040 633.0

(51) Int. Cl. G01C 21/36

(52) U.S. Cl. 701/201

(57) ABSTRACT

A method for operating a navigation system including at least one first user terminal and at least one navigation device includes the following steps:
a) inputting a destination and an appointed time into the user terminal;
b) transmitting a message from the user terminal to the navigation device by means of remote data transmission, wherein said message contains a destination and an appointed time;
c) receiving the message on the navigation device;
d) calculating a route on the navigation device, wherein this route leads from the current location to the destination received with the message; and
e) outputting the route.

### CROSS-REFERENCE TO RELATED APPLICATION

This application claims the priority benefit of German Patent Application No. 10 2007 040 633.0 filed on Aug. 27, 2007, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a method for operating a navigation system.

The inventive navigation system comprises at least one user terminal such as, for example, a mobile telephone, a personal computer, a pager or a mobile navigation device (Personal Navigation Assistant/PNA). The navigation system furthermore comprises at least one navigation device such as, for example, a mobile navigation device (PNA) or a personal computer with navigation software installed thereon or a mobile telephone with navigation application.

### BACKGROUND OF THE INVENTION

When planning a meeting between two or more persons, it is usually necessary to agree upon a time and the venue in the place of destination. To this end, the participating persons may contact one another, for example, via e-mail or telephone, and jointly agree upon the destination and/or the time of the meeting. In order to subsequently locate the destination, the different persons input the respective descriptive data such as, for example, the destination address on a navigation device that subsequently calculates a route to the destination.

This type of arranging a meeting between several persons is complicated and error-prone. The users need to read and input data on the navigation device several times, namely the data that respectively describes the destination and/or the appointed time of the meeting. Errors can occur very easily while reading and inputting the data and thusly interfere with the meeting.

### SUMMARY OF THE INVENTION

Based on this state of the art, the present invention therefore aims to propose a new method for operating a navigation system that simplifies the planning of meetings between several persons and eliminates sources of errors.

This objective is attained with a method for operating a navigation system including at least one first user terminal and at least one navigation device. The user terminal includes an input device for inputting operator commands and/or location data, particularly destinations and/or time data, especially appointed times. The user terminal includes a transmitting unit for transmitting user-generated messages via a communication system. The navigation device includes a receiving unit that makes it possible to receive messages from the communication system, a road network database, and a route calculating unit for calculating a planned route.

The method incorporating the present invention includes the following steps:
a) inputting a destination and an appointed time into the user terminal;
b) transmitting a message from the user terminal to the navigation device by means of remote data transmission, wherein said message contains a destination and an appointed time;
c) receiving the message on the navigation device;
d) calculating a route on the navigation device, wherein this route leads from the current location to the destination received with the message; and
e) outputting the route.

The method is based on the fundamental idea that the user terminal and the navigation device are able to exchange data in the navigation system via a communication system. The data flow leads from the user terminal to the navigation device in this case. In order to forward user-generated messages to the navigation device via the communication system, the user terminal is equipped with a suitable transmitting unit. This transmitting unit may be realized, for example, in the form of an SMS transmitting unit or e-mail software. The user terminal is also equipped with an input device that makes it possible to input operator commands, location data and time data.

The navigation device, in turn, is equipped with a receiving unit that makes it possible to receive messages transmitted from the user terminal via the communication system. The navigation device furthermore features a road network database for describing a geographic area in machine-readable form and a route calculating unit for calculating planned routes.

The core of the method consists of transmitting the essential data for agreeing upon a meeting between at least two persons, namely the destination and the appointed time of the meeting, without breaks in communication. This is ensured by initially inputting the destination and the appointed time on the user terminal. Subsequently, a message that contains the appointed time and the destination is generated on the user terminal. This message is then transmitted to the navigation device by means of remote data transmission such as, for example, in the form of an e-mail or via SMS. After the message has been received by the navigation device, the navigation device has definitive information on the destination and the appointed time such that input errors are precluded because the user does not intervene with the data flow for exchanging the destination and the appointed time. As soon as the navigation device has received the required information on the meeting in the form of the appointed destination and the appointed time, a route is calculated that directs the user from the current location to the destination received with the message. This route is then output for the user in suitable form, for example, displayed on a monitor or printed out on a printer.

In order to implement the method, it suffices, in principle, to calculate and output a route based on the destination data (venue, appointed time) received via the communication system. To this end, it would be possible, for example, to select a suitable road sequence from a database on a personal computer by utilizing suitable route calculating algorithms and to subsequently display or print out this road sequence on the monitor or printer, respectively. However, it is particularly advantageous if the user of the navigation device is also provided with assistance in locating the destination. For this purpose, the navigation device needs to be equipped with a signal receiving unit for receiving position signals such as, for example, signals of GPS-satellites, and a position determining unit for determining the current position based on the position signals. Mobile navigation devices such as, for example, PNAs usually have this functionality. Depending on the current position, the navigation device provides the user with maneuvering instructions in order to follow the route that was calculated based on the destination coordinates in the direction of the destination.

As disclosed herein, not only the destination coordinates, but also the appointed time of the meeting at the destination is transmitted from the user terminal to the navigation device. This appointed time can then essentially be processed arbitrarily in the navigation device. According to a first and particularly simple embodiment, the appointed time is output for the user on an output unit of the navigation device, for example, displayed on the monitor.

According to a variation of the method that is expanded with respect to the appointed time, the estimated driving time for traveling the route from the current location to the destination is calculated in the navigation device. Consequently, the navigation device has information, for example, on the expected time of movement, for example the driving time, required to reach the destination from the current location. Since the appointed time is also known, a suggested time of departure can be derived from the appointed time and the expected driving time and can be output for the user. This would make it possible, in particular, for the navigation device to remind the user of the impending departure such that the user can arrive at the destination at the appointed time with consideration of the expected driving time. It would furthermore be possible to output advance warning signals for the user prior to the suggested time of departure so as to remind the user of the departure in a timely fashion.

If a suggested time of departure was calculated by the navigation device, it can also be compared with the current time and a plausibility check can be carried out. During this plausibility check, it is determined if it is theoretically possible to arrive at the destination at the appointed time. If this plausibility check indicates that it is no longer possible to arrive at the destination at the appointed time based on the expected driving time, this negative result of the plausibility check is used for outputting a warning signal for the user in order to inform the user that it is no longer possible to arrive at the appointed time based on the expected driving time.

The message containing the destination and the appointed time essentially can be transmitted from the user terminal to the navigation device in any suitable way. However, this can be realized in a particularly simple and reliable fashion if the message is coded in accordance with a mobile communication text message (SMS, MMS, WAP) or in accordance with an Internet text message (e-mail, TCP-IP).

The user of the user terminal needs to input the destination coordinates on the user terminal. This can be realized, for example, with an alphanumeric keypad or by selecting destinations stored in a database. However, an exact description of the destination is frequently not available to the user. On the contrary, the user would like to arrange a meeting at his current position. If the user terminal features a signal receiving unit for receiving position signals such as, for example, position signals of GPS-satellites and a position determining unit for determining the current position based on the position signals, the current position can be determined in response to a corresponding request by the user and the coordinates of the current position can be used for generating the message to be transmitted to the navigation device. This means that the current position of the user terminal is transmitted to the navigation device in response to a corresponding request by the user. A route that directs the user of the navigation device to the location of the user terminal can then be calculated in the navigation device.

If the position of the user terminal changes, for example, because the user of the user terminal moves from one point to another point, the route that was calculated by the navigation device and output for the user of the navigation device needs to be changed accordingly

According to one variation of the method, this can be achieved by dynamically updating and repeatedly transmitting the current position of the user terminal to the navigation device. For example, it would be conceivable to determine the current position of the user terminal anew within specified time intervals, for example, every five minutes, and to transmit the result of the position determination to the navigation device in the form of a message. This makes it possible to take into consideration and incorporate changes in the location of the user terminal in the route planning.

In the basic variation of the method, the message containing the destination data is directly transmitted from the user terminal to the navigation device. This may be realized, for example, by transmitting an SMS message with the destination coordinates and the appointed time from a mobile telephone to a mobile navigation device. However, it is not absolutely imperative to realize a direct data transmission. On the contrary, the communication system may also contain an intermediate message server that receives the message containing the destination and the appointed time from the user terminal and transmits this message to the navigation device on demand. This makes it possible, in particular, to realize a deferred transmission of the destination data between the user terminal and the navigation device. In addition, an intermediate message server makes it possible to forward the destination data to a number of navigation devices without requiring the user of the user terminal to generate a corresponding number of messages.

The method is particularly advantageous if a meeting is to be arranged between a large number of persons. In this case, the message containing the destination data (venue, appointed time) is not only transmitted to one navigation device, but rather to several navigation devices. The navigation devices designated for the transmission of the message may, for example, belong to a common group of recipients. If a member of this group wants to invite other members of the group to a meeting, he transmits a corresponding message that is then automatically forwarded to all members of the group and their navigation devices. Corresponding applications may preferably be installed on so-called community servers. The community server can assist the user of the user terminal with the generation of the destination coordinates. It would be conceivable, for example, that the user of the user terminal transmits certain destination criteria to the community server, wherein these destination criteria are then automatically evaluated by the community server. The destination criteria may consist, for example, of the desired type of meeting (dinner, movie, theater), from which the community server can then derive corresponding destinations.

One particularly important destination criterion for arranging a meeting between several persons is the respective location of the users. A destination should preferably be agreed upon in such a way that the distance to be driven by the users is as short as possible. According to one variation of the method, it is therefore proposed that the current location of the user terminal and/or the current location of at least one navigation device is/are transmitted to the community server. The community server then calculates a suitable destination based on all current locations received and forwards this destination to all navigation devices.

In order to enable members of a community group to also arrange meetings in a deferred fashion, it is particularly advantageous if the destination is stored in the community server under a certain addressing. The message with the description of the destination data transmitted from the user terminal to the navigation devices then not only contains the destination data itself, but also the addressing of the destination data in the community server. The navigation devices can automatically retrieve the corresponding data from the community server with this addressing.

Different aspects of the invention are schematically illustrated in the figures and are described in an exemplary fashion below.

### BRIEF DESCRIPTION OF THE DRAWINGS

FIG. 1 shows a first navigation system during the implementation of a method incorporating the present invention;

FIG. 2 shows a second navigation system during the implementation of a method incorporating the present invention;

FIG. 3 shows a third navigation system during the implementation of a method incorporating the present invention; and

FIG. 4 shows a fourth navigation system during the implementation of a method incorporating the present invention.

### DETAILED DESCRIPTION OF THE EXAMPLE EMBODIMENTS

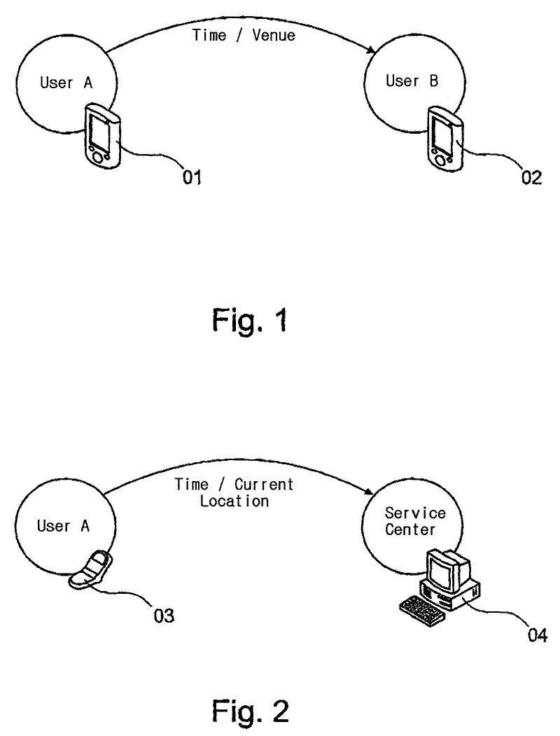

FIG. 1 shows a navigation system consisting of a user terminal 01, namely a mobile navigation device, and a navigation device 02 that is also realized in the form of a mobile navigation device. In order to arrange a meeting between the user A of the user terminal 01 and the user B of the navigation device 02, the user A can input the desired destination data, namely the destination and the appointed time, on the user terminal 01. This data is then transmitted to the navigation device 02 via remote data transmission and is automatically incorporated into the route calculation of the navigation device 02. The navigation device 02 subsequently calculates a route for the user B that directs the user B from his current location to the desired destination. The maneuvering instructions required for following the route are acoustically announced and displayed on the display unit for the user B by the navigation device 02.

FIG. 2 shows a navigation system with a user terminal 03, namely a mobile telephone with a navigation application installed thereon, and a navigation device 04, namely a personal computer with navigation software installed thereon. The navigation device 04 may consist, for example, of the service center of a taxi service or the service center of an ambulance service. Upon a corresponding request by the user A, the user terminal 03 determines its current position and transmits this current position to the navigation system 04 together with a desired time via remote data transmission. The navigation system then calculates a route to the current location of the user A that directs, for example, an ambulance or a taxi from its current position to the location of the user A.

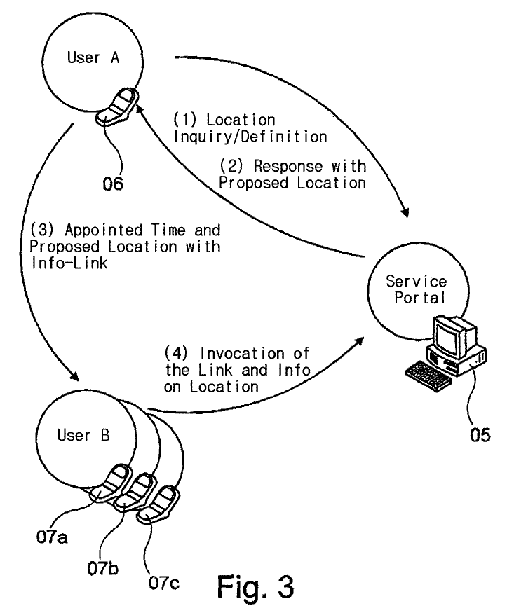

FIG. 3 shows a navigation system, in which a service portal computer 05 that serves as community server is incorporated into the communication between a user terminal 06, namely a mobile telephone with navigation application, and several navigation devices 07a to 07c. The user A initially submits a destination inquiry from his user terminal 06 to the community server 05 via remote data transmission. Certain destination criteria that should be observed for a meeting with several users B are specified in this destination inquiry. Based on these destination criteria, the community server 05 determines a suitable destination, for example, a restaurant, a location for a barbecue or the like.

This proposed destination is intermediately stored in the community server 05 together with the destination coordinates and is simultaneously transmitted to the user A via remote data transmission. In addition to the actual proposed destination, the message of the community server 05 to the user A also contains a link to the destination coordinates stored in the community server 05. The user A then transmits the destination data including the appointed time and the link to the destination coordinates stored in the community server 05 to the navigation devices 07a to 07c of the users B that belong to the common user group. This link is then used by the navigation devices 07a to 07c for retrieving the destination coordinates from the community server 05, wherein the destination coordinates are automatically loaded into the navigation routine in order to calculate the route.

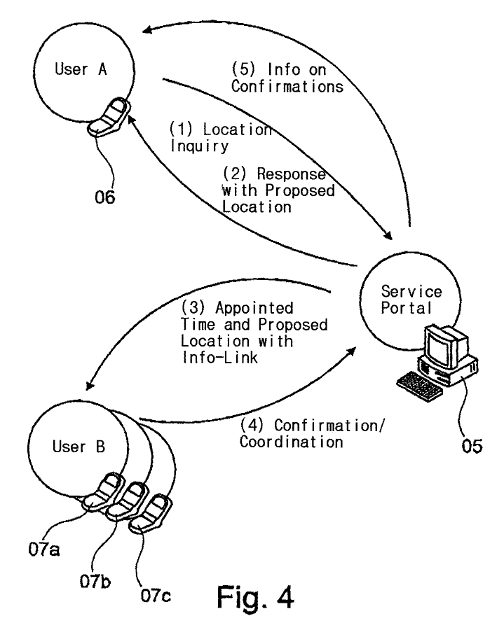

FIG. 4 shows a navigation system that represents a variation of the navigation system shown in FIG. 3. In contrast to the navigation system shown in FIG. 3, the destination data (venue, appointed time) is not directly transmitted from the user A to the user B in the navigation system according to FIG. 4, but rather switched via the community server 05. This means that the appointed time and the destination coordinates are transmitted from the community server 05 to the navigation devices 07a to 07c. If the users B of the navigation devices 07a to 07c agree with the desired meeting, confirmations are transmitted from the navigation devices 07a to 07c to the community server 05 and these confirmations are forwarded from the community server 05 to the user terminal 06 of the user A.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for operating a navigation system comprising at least one first user terminal (01, 03, 06) and at least one navigation device (02, 04, 07),
wherein the user terminal (01, 03, 06) comprises an input device for inputting operator commands and/or location data, particularly destinations and/or time data, especially appointed times,
and wherein the user terminal (01, 03, 06) comprises a transmitting unit for transmitting user-generated messages via a communication system,
and wherein the navigation device (02, 04, 07) comprises a receiving unit that makes it possible to receive messages from the communication system,
and wherein the navigation device (02, 04, 07) comprises a road network database,
and wherein the navigation device (02, 04, 07) comprises a route calculating unit for calculating a planned route,
with said method comprising the following steps:
a) inputting a destination and an appointed time into the user terminal (01, 03, 06);
b) transmitting a message from the user terminal (01, 03, 06) to the navigation device (02, 04, 07) by means of remote data transmission, wherein said message contains a destination and an appointed time;
c) receiving the message on the navigation device;
d) calculating a route on the navigation device (02, 04, 07), wherein this route leads from the current location to the destination received with the message; and
e) outputting the route.

2. The method according to claim 1, in which the navigation device (02, 04) comprises a signal receiving unit for receiving position signals, particularly GPS-signals, wherein the navigation device (02, 04) determines the current position based on the position signals by means of a position determining unit, and wherein the navigation device (02, 04) outputs maneuvering instructions in order to follow the route in dependence on the current position.

3. The method according to claim 1, in which the appointed time is output, particularly displayed, on the output unit of the navigation device (02, 04, 07).

4. The method according to claim 1, in which the expected driving time for traveling the route from the current location to the destination received with the message is calculated in the navigation device (02, 04), wherein a proposed time of departure is derived from the appointed time received and the expected driving time.

5. The method according to claim 4, in which a plausibility check between the proposed time of departure and the current time is carried out and a warning signal can be output in dependence on the result of the plausibility check.

6. The method according to claim 1, in which the message containing the destination and the appointed time is transmitted between the user terminal (01, 03, 06) and the navigation device (02, 04, 07) in the form of a mobile communication text message (SMS, MMS, WAP) or an Internet text message (e-mail, TCP-IP).

7. The method according to claim 1, in which the user terminal (01, 03, 06) comprises a signal receiving unit for receiving position signals, particularly GPS-signals, wherein the user terminal determines the current position based on the position signals by means of a position determining unit, and wherein the current position of the user terminal (01, 03, 06) is transmitted as the destination with a message from the user terminal (01, 03, 06) to the navigation device (02, 04, 07).

8. The method according to claim 7, in which the current position of the user terminal (01, 03, 06) is dynamically updated and repeatedly transmitted to the navigation device (02, 04, 07).

9. The method according to claim 1, in which the communication system comprises a message server, particularly a community server (05), wherein the message with the destination and the appointed time is transmitted from the user terminal (06) to the message server (05) and then from the community server (05) to the navigation device (07), particularly in a deferred fashion.

10. The method according to claim 1, in which the message with the destination and the appointed time is transmitted from the user terminal (06) to several navigation devices (07a, 07b, 07c), particularly to navigation devices that belong to a common group of recipients.

11. The method according to claim 1, in which a community server (05) derives the destination by evaluating specified destination criteria.

12. The method according to claim 11, in which the destination is derived by the community server (05) with consideration of the current location of the user terminal (06) and/or with consideration of the current location of at least one navigation device (07).

13. The method according to claim 11, in which the destination is stored in the community server (05) under a certain addressing, wherein the message transmitted from the user terminal (06) to the navigation device (07) contains the addressing of the destination in the community server (05).
